(19) United States
(12) Patent Application Publication
(10) Pub. No.: US 2005/0179284 A1
(43) Pub. Date: Aug. 18, 2005

(54) Motor-less vehicle

(76) Inventor: Salomon Sandro Galitzky, Spring Valley, NY (US)

Correspondence Address: SALOMON SANDRO GALITZKY, 23 EISENHOWER AVE, SPRING VALLEY, NY, 10977, US

(21) Appl. No.: 10/986,664

(22) Filed: Nov. 12, 2004

Related U.S. Application Data
(60) Provisional application No. 60/545,636, filed on Feb. 18, 2004.

(51) Int. Cl. B60R 15/00

(52) U.S. Cl. 296/181.1

(57) ABSTRACT

A vehicle-extension that provides extra seating space to accommodate . . . All family members & friends. Car pool. Crews & Clubs. Eliminates traffic. Fuel-efficient. Plenty room for “Car Seats”. Enforces safe-driving codes.

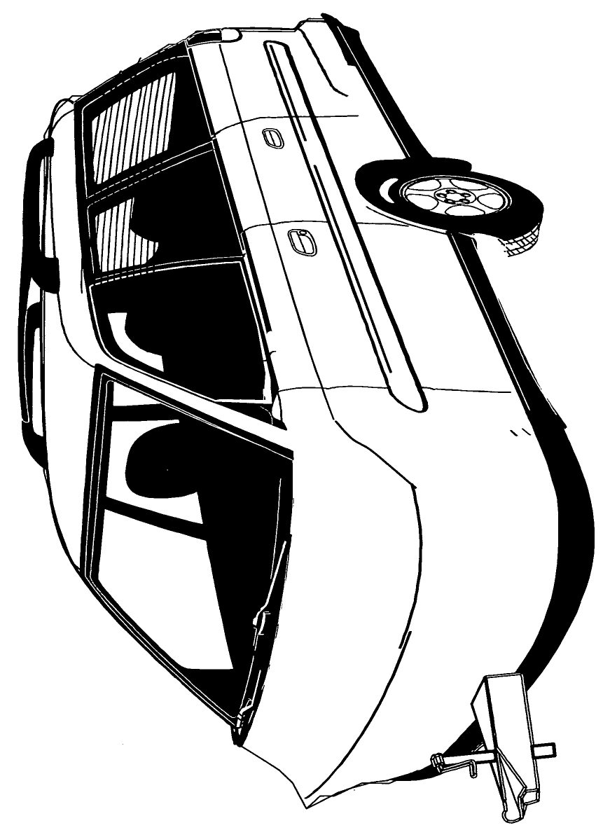

### BACKGROUND FOR THE PURPOSE OF THE INVENTION

The fact that I have seen and being involved many times in a situation of leaving behind sum of my family because there was no room “legally” in my vehicle, and as my practice in the construction line I witnessed many times that contractors with pickup-trucks couldn't deliver their crew for the lack of room in their car I came to the conclusion of inventing the above said “Motorless-vehicle”.

### BACKGROUND FOR—HOW IT WILL SERVE THE SOCIETY

Provides extra seating space to accommodate . . .
All family & friends.
Car pool.
Crews & Clubs.
Eliminates traffic.
Fuel-efficient.
Plenty room for “Car Seats”.
Enforces safe-driving codes.

### DEFINITIONS FOR THIS BACKGROUND DISCUSSION

The term “Vehicle” refers that the cabin is designed to transport people but with no own power just it's hooks on to the back of another vehicle trough a hitch.

The following specifications for this invention the term “motor-less” refers to a cabin that comforts passengers sitting inside (similar to a minivan or SUV) with no operating engine that brings the cabin to move, riding on two tires that are placed in the center of the body.

A provisional Patent has been granted by the patent office on Feb. 18, 2004 and mailed on Apr. 26, 2004 the application number is 60/545,636 enclosed I'm sending a copy of the document.

1. That my invention named as “The Motor-less Vehicle” is comprising of a body of a car with seats inside and no engine, riding on two (or more) tires, that hooks on to the back of any vehicle, and gives the opportunity to legally transport more passengers than in a ordinary automobile.
